(19) United States
(12) Patent Application Publication
(10) Pub. No.: US 2003/0182360 A1
(43) Pub. Date: Sep. 25, 2003

(54) Java telematics system preferences

(75) Inventors: Darryl J. Mocek, San Jose, CA (US); Nikolay Georgievich Grigoriev, St. Petersburg (RU); Sergey Petrovsky, Moscow (RU)

Correspondence Address: MARTINE & PENILLA, LLP, 710 LAKEWAY DRIVE, SUITE 170, SUNNYVALE, CA, 94085, US

(73) Assignee: Sun Microsystems, Inc., Palo Alto, CA

(21) Appl. No.: 10/104,246

(22) Filed: Mar. 22, 2002

(51) Int. Cl. G06F 15/16

(52) U.S. Cl. 709/203

(57) ABSTRACT

A system for storing preferences on a telematics client is provided. The system includes a telematics server configured to receive a request containing modification data for preferences. The modification data for the preferences is stored on a preference server of the telematics server. The telematics server includes a server side communications framework in communication with the preference server. The telematics control unit (TCU) has a preference manger for storing the preferences. The TCU includes a client side communications framework in communication with the preference manager, wherein the preference manager and the preference server are configured to synchronize over a network connection to allow the modification data to be communicated between the preference server and the preference manager.

### CROSS REFERENCE TO RELATED APPLICATIONS

This application is related to (1) U.S. patent application Ser. No. ______ (Attorney Docket No. SUNM084), filed Mar. 22, 2002, and entitled “Adaptive Connection Routing Over Multiple Communication Channels,” (2) U.S. patent application Ser. No. ______ (Attorney Docket No. SUNMP086), filed Mar. 22, 2002, and entitled “Arbitration of Communication Channel Bandwidth,” (3) U.S. patent application Ser. No. ______ (Attorney Docket No. SUNMP087), filed Mar. 22, 2002, and entitled “System and Method for Distributed Preference Data Services,” (4) U.S. patent application Ser. No. ______ (Attorney Docket No. SUNMP088), filed Mar. 22, 2002, and entitled “Asynchronous Protocol Framework,” (5) U.S. patent application Ser. No. ______ (Attorney Docket No. SUNMP089), filed Mar. 22, 2002, and entitled “Business-Model Agnostic Service Deployment Management Service,” (6) U.S. patent application Ser. No. ______ (Attorney Docket No. SUNMP090), filed Mar. 22, 2002, and entitled “Manager Level Device/Service Arbitrator,” (7) U.S. patent application Ser. No. ______ (Attorney Docket No. SUNMP093), filed Mar. 22, 2002, and entitled “System and Method for Testing Telematics Software,” (8) U.S. patent application Ser. No. ______ (Attorney Docket No. SUNMP094), filed Mar. 22, 2002, and entitled “System and Method for Simulating an Input to a Telematics System,” (9) U.S. patent application Ser. No. ______ (Attorney Docket No. SUNMP095), filed Mar. 22, 2002, and entitled “Java Telematics Emulator,” and (10) U.S. patent application Ser. No. ______ (Attorney Docket No. SUNMP096), filed Mar. 22, 2002, and entitled “Abstract User Interface Manager with Prioritization,” which are incorporated herein be reference.

### BACKGROUND OF THE INVENTION

1. Field of the Invention

This invention relates generally to network-centric telematics services and applications supplied to vehicles and more particularly to a telematics system configured to provide storage for user preferences.

2. Description of the Related Art

The electronic content and sophistication of automotive designs has grown markedly. Microprocessors are prevalent in a growing array of automotive entertainment safety and control functions. Consequently, this electronic content is playing an increasing role in the sales and revenues of the automakers. The features provided by the electronic content include audio systems, vehicle stability control, driver activated power train controls, adaptive cruise control, route mapping, collision warning systems, etc. The significant increase of the electronic content of land based vehicles has concomitantly occurred with the explosive growth of the Internet and the associated data driven applications supplied through mobile applications.

Telematics, a broad term that refers to vehicle-based wireless communication systems and information services, promises to combine vehicle safety, entertainment and convenience features through wireless access to distributed networks, such as the Internet. Telematics offers the promise to move away from the hardware-centric model from audio and vehicle control systems that are built into devices that are custom designed for each vehicle, to infotainment delivered by plug-and-play hardware whose functionality can be upgraded through software loads or simple module replacement. Furthermore, new revenue streams will be opened up to automobile manufacturers and service providers through the products and services made available through telematics.

Since these infotainment systems integrate entertainment and information within a common envelope, the systems need to be highly integrated, open and configurable. However, the electronic systems currently on the market are custom designed for the make, model, year and world region in which the vehicle is sold. Additionally, the electronic systems being used today are linked by proprietary busses having severely limited bandwidth that are inadequate for data-intensive services combining information entertainment and safety. The proprietary and customized systems require a developer to know the underlying software and hardware application program interfaces (APIs) in order to develop applications for future infotainment systems. However, numerous proprietary and customized systems are spread across the various makes and models of the vehicles in the marketplace and even within the same models from year to year. Thus, the heterogeneous nature of the various systems essentially eliminates any benefits of economies of scale since equipment and software must be tailored to each model permutation.

Furthermore, a user's desired settings or preferences for the configuration of a telematics system need to be stored so that the user only sets the preferences once. Additionally, the user must have easy access to add, delete, or modify the preferences. Additionally, any changes to the preferences while the in-vehicle telematic control unit is in a sleep mode must be handled in a manner such that the changes will be stored on the server side until the telematic control unit is “awakened”. Therefore, the in-vehicle telematics system will not be able to update the preferences until the vehicle is powered.

In view of the forgoing, there is a need for a system and method to store user and system preferences for a telematics control unit in order for a user and the system to make changes to the preferences at will.

### SUMMARY OF THE INVENTION

Broadly speaking, the present invention fills these needs by providing storage for new preferences and preference modifications where the preferences and the modifications are stored in a client, on a server and communicated through synchronized channels. It should be appreciated that the present invention can be implemented in numerous ways, including as an apparatus, a system, a device, or a method. Several inventive embodiments of the present invention are described below.

In one embodiment, a system for storing preferences on a telematics client is provided. The system includes a telematics server configured to receive a request containing modification data for preferences. The modification data for the preferences is stored on a preference server contained within the telematics server, such as a Java provisioning server. The telematics server includes a server side communications framework in communication with the preference server. The telematics control unit (TCU) has a preference manager for storing the preferences. The TCU includes a client side communications framework in communication with the preference manager, wherein the preference manager and the preference server are configured to synchronize over a network connection to allow the modification data to be communicated between the preference server and the preference manager.

In another embodiment, a telematics control unit (TCU), is provided. The telematics control unit includes a software stack. The software stack includes an operating system (OS) layer, a service gateway layer; a Java virtual machine (JVM) layer and a Java telematics client (JTC) layer. The JTC layer includes a client side communication framework configured to communicate with a server side communication framework. Also included in the client side communication framework is a user interface manager and a preference manager in communication with the client side communication framework. The preference manager is configured to store preferences.

In yet another embodiment, a method for storing preferences associated with a telematics system is provided. The method initiates with selecting a preference. Then, the selected preference is stored in storage of a preference server. Next, the preference server is synchronized with a preference manager of a telematics control unit (TCU). Then, the preference is transmitted to the preference manager. Next, the preference is stored in storage of the TCU.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings.

FIG. 1 is a high level schematic overview of an automotive telematics system in accordance with one embodiment of the invention.

FIG. 2 is a schematic diagram of a telematics client communicating through a wireless network with a telematics server in accordance with one embodiment of the invention.

FIG. 3 is a three dimensional pictorial representation of a telematics client implementation of the client side stack of FIG. 2 in accordance with one embodiment of the invention.

FIG. 4 is a high level schematic diagram of the interaction between a carlet and a communications framework on the client side of a telematics system in accordance with one embodiment of the invention.

FIG. 5 is a high level schematic diagram of a telematics system providing a preference service for the storage of preferences in accordance with one embodiment of the invention.

FIG. 6 is a schematic diagram providing a two dimensional view of the layers of the software stack of the TCU in accordance with one embodiment of the invention.

FIG. 7 illustrates communication between a carlet application and the communications framework on the client side in accordance with one embodiment of the invention.

FIG. 8 is a flowchart diagram of the method operations performed for setting a preference in a TCU in accordance with one embodiment of the invention.

### DETAILED DESCRIPTION OF THE PREFERRED EMBODIMENTS

An invention is disclosed for telematics system having the capability to store preferences and modification data for the preferences. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

The embodiments of the invention described herein provide a system and method for storing preferences defined by a user with respect to a telematics system for a vehicle. As will be explained in more detail below, the preferences allow for the configuration of a telematics control unit to provide the desired functionality as dictated by a user. That is, if the user desires to pre-set certain radio stations, environmental conditions in the cabin, infotainment settings, convenience settings, etc., then the user may specify these desired settings as preferences. These preferences must be stored so that each time the user starts the vehicle, the preferences will be set. In one embodiment, the preferences are input, uploaded, or modified to a server when the telematics control unit of the vehicle is in a sleep mode, therefore, the preferences are stored on the server and transmitted to the client upon startup and establishment of a communication link with the client. It should be appreciated that the preferences can also be selected from the client and uploaded to the server.

An in-vehicle telematics control unit (TCU) can tie into any of the control systems, safety systems, entertainment systems, information systems, etc., of the vehicle. It will be apparent to one skilled in the art that the client side stack of the TCU is utilized to access a vehicle interface component for accessing in-vehicle devices, such as the speedometer, revolutions per minute (rpm) indicator, oil pressure, tire pressure, etc. Thus, client side applications sitting in the TCU will allow for the functionality with respect to the vehicle systems as well as infotainment applications.

In one embodiment, the telematics system deploys Java technology. It should be appreciated that Java technology's platform-independence and superior security model provide a cross-platform solution for the heterogeneous systems of a vehicle while maintaining a security architecture protecting against viruses and unauthorized access. Thus, the content or service provider is insulated against the myriad of car platforms while vehicle manufacturers are protected against hacker threats. In addition, Java application program interfaces (APIs) are available to support telematics mediums, such as speech recognition through Java Speech API (JSAPI), media delivery through Java Media Framework (JMF) and wireless telephony through Wireless telephony communications APIs (WTCA), etc.

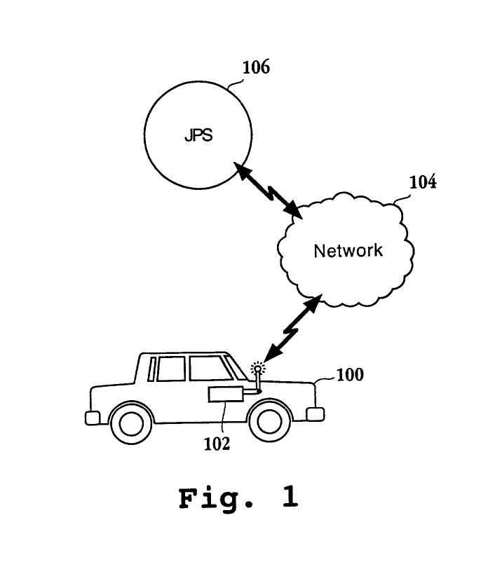

FIG. 1 is a high level schematic overview of an automotive telematics system in accordance with one embodiment of the invention. A client/server architecture relying on standards and principles of modular design allows for functionality of the telematics system to be delivered to the customer through wireless access. The server side includes Java provisioning server (JPS) 106 in communication with network 104. For a detailed description of JPS 106 please refer to U.S. patent application Ser. No. ______, attorney docket number SUNMP084, filed on ______, 2002 and entitled “Adaptive Connection Routing Over Multiple Communication Channels,” which is incorporated herein by reference in its entirety. The client side includes telematics control unit (TCU) 102 contained within the body of land based vehicle 100. TCU 102 is enabled to communicate with network 104 through wireless access. Of course, network 104 can be any distributed network such as the Internet and the wireless access protocol (WAP) can be any suitable protocol for providing sufficient bandwidth for TCU 102 to communicate with the network. It should be appreciated that the client/server architecture of FIG. 1 allows for the evolution from hard wired, self contained components to platform based offerings relying on software and upgrades. Thus, a service provider controlling JPS 106 can deliver an unbundled, open end-to-end solution enabling plug and play applications. For example, the service can be a tier-based service similar to home satellite and cable services. It will be apparent to one skilled in the art that an open platform, such as frameworks based on Java technology, enables a developer to create executable applications without regard to the underlying hardware or operating system. While FIG. 1 illustrates an automobile, it should be appreciated that TCU 102 can be incorporated in any vehicle or mode of transportation whether it is land based or non-land based. For example, a boat, a plane, a helicopter, etc. can incorporate TCU 102.

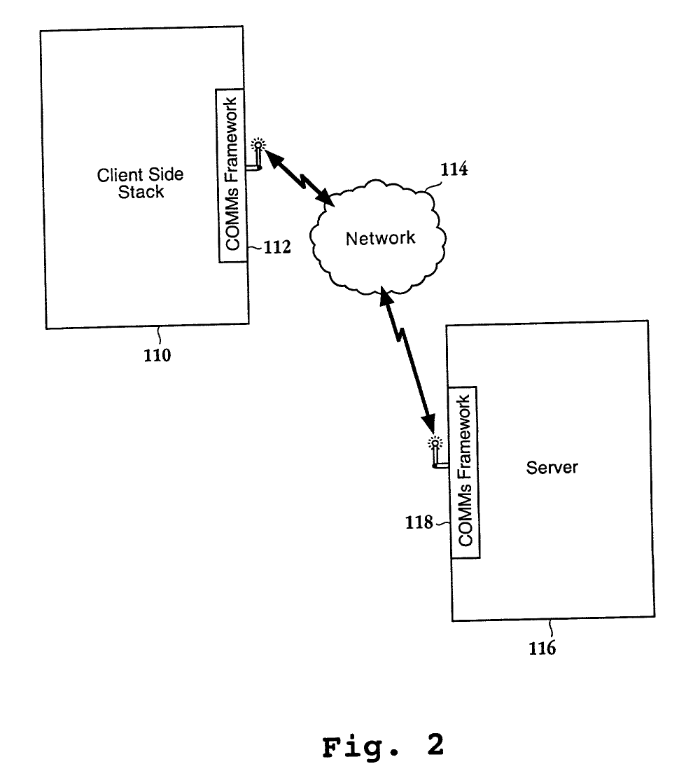

FIG. 2 is a schematic diagram of a telematics client communicating through a wireless network with a telematics server in accordance with one embodiment of the invention. Client side stack 110 includes the necessary layers for a client application, also referred to as a manager or a carlet, to be executed to provide functionality. As will be explained further below, the carlet has access to each layer of the client side stack 110. Included in client side stack 110 is client communication framework 112. Client communication framework 112 enables communication between the client side stack 110 and an application on server 116 through network 114. It should be appreciated that server 116 is not limited to a wireless connection. For example, server 116 can be hardwired into network 114. One skilled in the art will appreciate that where server 116 communicates through a wireless connection with network 114, the communication proceeds through server communication framework 118. With respect to an embodiment where server 116 is hardwired to network 114, the server can communicate with network 114 through a network portal (e.g. the Internet) rather than server communication framework 118. Additionally, network 114 can be any suitable distributed network, such as the Internet, a local area network (LAN), metropolitan area network (MAN), wide area network (WAN), etc.

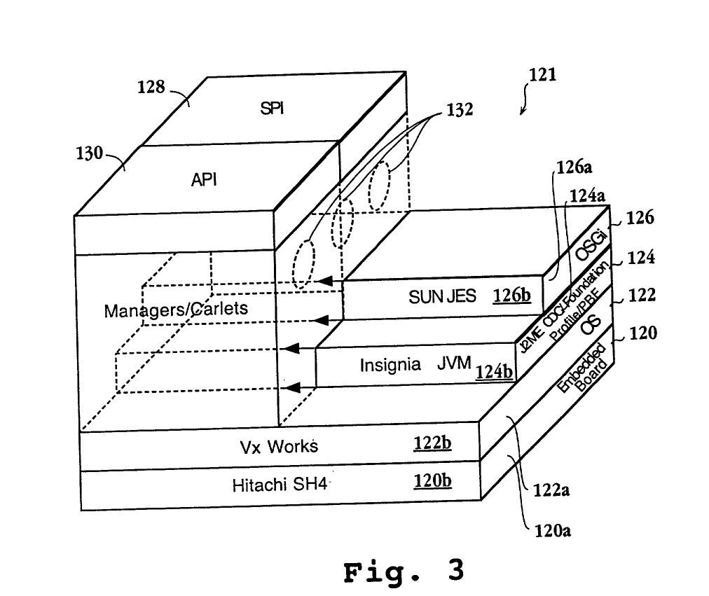

FIG. 3 is a three dimensional pictorial representation of a telematics client implementation of the client side stack of FIG. 2 in accordance with one embodiment of the invention. Client side implementation 121 includes hardware layer 120 of the client includes an embedded board containing a telematics control unit (TCU). As mentioned with reference to FIG. 1, the TCU is incorporated into a land based vehicle. In one embodiment, the TCU is in communication with the electronic components of a vehicle through a vehicle bus or other communication means. These components include the measurement of vehicle operating and safety parameters, such as tire pressure, speed, oil pressure, engine temperature, etc., as well as information and entertainment components, such as audio system settings, internet access, environmental control within the cabin of the vehicle, seat positions, etc. One skilled in the art will appreciate that the telematics control unit is capable of integrating the functionality of various handheld information and entertainment (infotainment) devices, such as mobile phones, personal digital assistants (PDA), MP3 players, etc.

Still referring to FIG. 3, operating system layer 122 sits above hardware layer 120. Java virtual machine (JVM) layer 124 sits on top of operating system (OS) layer 122 and open services gateway initiative (OSGI) layer 126 sits on top of the JVM layer. It should be appreciated that the standard for JVM layer 124 includes Java 2 Platform Micro Edition (J2ME), Connected Device Configuration (CDC), Connected Limited Device Configuration (CLDC), Foundation Profile, Personal Profile or Personal Basis Profile. One skilled in the art will appreciate that J2ME Foundation Profile is a set of APIs meant for applications running on small devices that have some type of network connection, while J2ME CDC Personal Profile or Personal Basis Profile provides the J2ME CDC environment for those devices with a need for a high degree of Internet connectivity and web fidelity. The standards for each of the layers of the stack are provided on the right side of client side implementation 121. In particular, OSGI 126a, J2ME CDC 124a, OS 122a, and embedded board 120a are standards and to the left of the standards are examples of actual products that implement the standards. For example, OSGI 126a standard is implemented by Sun's Java Embedded Server (JES) 2.1 126b, J2ME 124a standard is implemented by Insignia's Virtual Machine 124b, OS 122a is implemented by Wind River's VxWorks real time operating system 122b, and embedded board 120a is an embedded personal computer based board such as Hitachi's SH4. It should be appreciated that the actual products are exemplary only and not meant to be limiting as any suitable product implementing the standards can be utilized.

Carlets 132 of FIG. 3, have access to each layer above and including OS layer 122. Application program interface (API) layer 130 is the layer that carlets use to communicate with the JTC. Service provider interface (SPI) layer 128 is a private interface that managers have among each other. One skilled in the art will appreciate that OSGI layer 126 provides a framework upon which applications can run. Additional functionality over and above the JVM, such as lifecycle management is provided by OSGI layer 126. It should be appreciated that the open services gateway initiative is a cross industry working group defining a set of open APIs for a service gateway for a telematics systems. These APIs consist of a set of core framework APIs. In order to deploy services and their implementations OSGI defines a packaging unit called a service bundle. A service bundle is a Java Archive (JAR) file containing a set of service definitions along with their corresponding implementation. Both infrastructure services and carlets are deployed as service bundles. Some of the functionality for arbitrating, controlling and managing devices and resources, e.g., speakers, cell phones, etc., by OSGI layer 126. However, one skilled in the art will appreciate that a separate arbitration service may also be required. As used herein, a carlet is a Java application. For each function or task to be processed on the client side or between the client and server sides, a carlet is invoked to manage the operation. In this manner, carlets can be independently written, tested, and launched for use on a telematics system. By way of example, a carlet can be written to control or monitor the activity of automobile components (e.g., tires, engine oil, wiper activity, steering tightness, maintenance recommendations, air bag control, transmission control, etc.), and to control or monitor applications to be processed by the telematics control unit (TCU) and interacted with using the on-board automobile monitor. As such, specialized carlets can be written to control the audio system, entertainment modules (e.g., such as on-line games or movies), voice recognition, telecommunications, email communications (text and voice driven), etc. Accordingly, the type of carlets that can be written is unlimited. Carlets may be pre-installed or downloaded from a sever. A carlet may or may not have an API which may be invoked by other carlets and it may or it may not have running threads of its own.

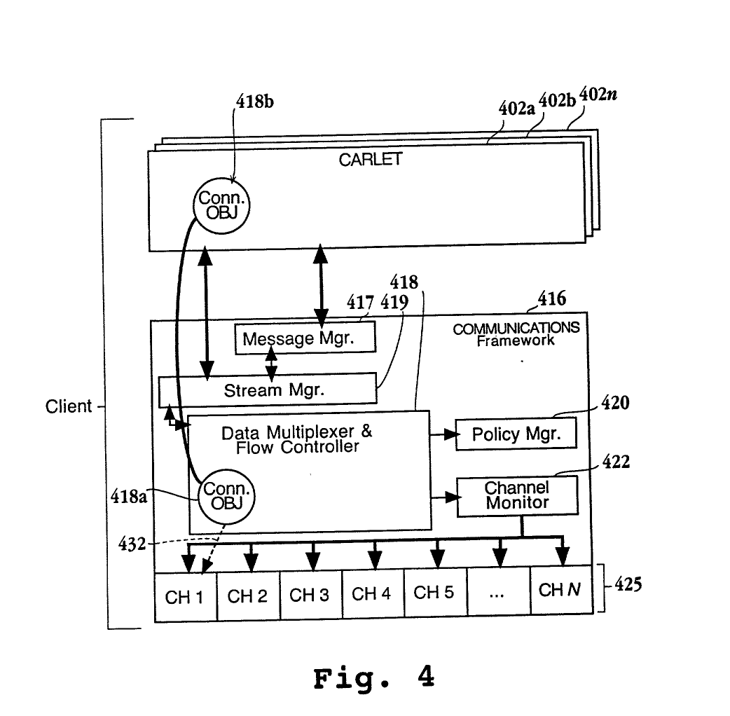

FIG. 4 is a high level schematic diagram of the interaction between a carlet and a communications framework on the client side of a telematics system in accordance with one embodiment of the invention. It should be appreciated that the server side has a similar communication framework to establish and enable synchronous communication between the client side (e.g., a telematics control unit on a vehicle) and the server side (e.g., a Java telematics server). The communications framework 416 includes a message manager 417, a stream manager 419, a data multiplexer and flow controller 415, a policy manager 420, a channel monitor 422, and an interface to the various physical channels available to the communications framework of the client side.

Still referring to FIG. 4, when a particular carlet application 402 is requested, the carlet will communicate with the stream manager 419 and request that a connection be established. In response, the stream manager 419 will request a connection object (Conn. OBJ) 418a from the data multiplexer and flow controller 415. Once a channel satisfying the request is available, the data multiplexer and flow controller 415 will return a connection object (Conn. OBJ) 418b back to the carlet. Thus, a communication link is established between the carlet application 402 via the connection objects 418a and 418b of the data multiplexer and flow controller 415. In one embodiment, the connection object 418a of the data multiplexer and flow controller 415 has the ability to switch between channels 425 that are available to the communications framework 416 of the client side. Here, code contained in the policy manager enables selection of different channels depending upon availability, the type of communication desired, bandwidth requirements for a given data transfer or transfers, payment of a bandwidth fee, subscription level, etc.

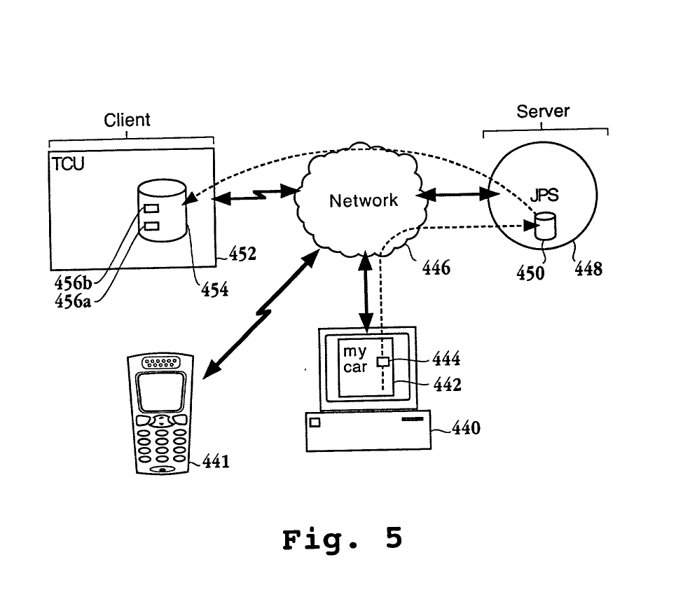

FIG. 5 is a high level schematic diagram of a telematics system providing a preference service in accordance with one embodiment of the invention. Here, a user can set a preference from a workstation such as personal computer 440. Personal computer 440 is connected to network 446 to access web page 442 to allow a user to set or modify preferences. For example, a user may desire to set a radio station as a preference from a home computer so that the radio station will be available as a preference the next time the user's vehicle containing a telematics control unit (TCU) is started. In one embodiment, web page 442 includes a list of preferences 444 of the user. Of course, the user can specify a preference rather than choose from a list when customizing preferences. The user has the ability to change, add, or delete preferences 444 from the list. One skilled in the art will appreciate that a user may also access the web page 442 through a handheld device 441, such as a personal digital assistant, web-enabled mobile phone, etc. In the example where the user desires to add preference 444 to preferences stored on the TCU of the vehicle, a request to store preference 444 is sent over network 446 to Java provisioning server (JPS) 448. JPS 448 stores the data for preference 444 in storage 450. It should be appreciated that JPS 448 is a component of the backend (server side) of the telematics system.

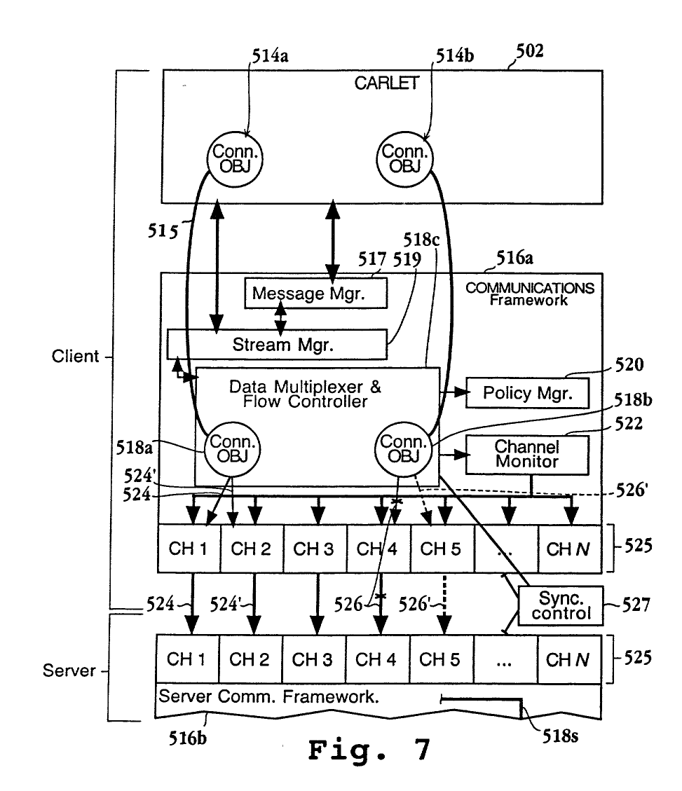

Still referring to FIG. 5, JPS 448 includes a communication framework configured to synchronize a preference server of the JPS with a preference manager of TCU 452 through a communication framework of the TCU, as will be explained in more detail with reference to FIG. 7. Upon synchronization of the preference server and the preference manager, the data for preference 444 is transmitted to storage 454 of TCU 452 (client side) through network 446. In one embodiment, synchronization between the preference server and the preference manager occurs upon startup of the vehicle containing TCU 452 is started. Once the data for preference 444 is stored in TCU 452, the preference is available to the user. That is, where the preference is a radio station, the radio station is now available to the user. It should be appreciated that preferences can either be system preferences 456a or user preferences 456b. System preferences include data that the telematics system stores such as vehicle identification number (VIN), license plate of vehicle, phone number to connect with JPS 448, etc. User preferences include infotainment and convenience preferences, i.e., preferences directed towards information and entertainment, such as radio station settings, climate control, email, news, etc. In one embodiment application preferences are included. One skilled in the art will appreciate that application preferences are preferences that the application stores for itself.

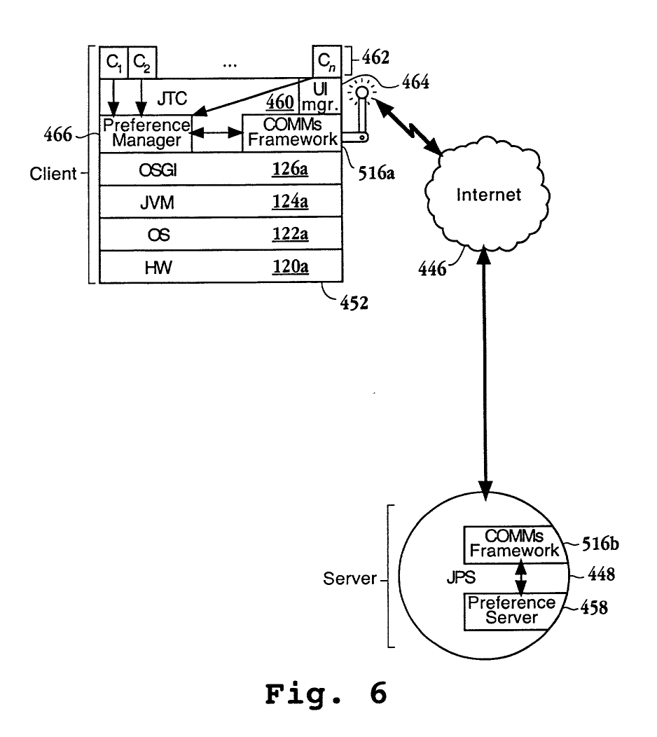

FIG. 6 is a schematic diagram providing a two dimensional view of the layers of the software stack of the TCU in accordance with one embodiment of the invention. Software stack of TCU 452 defines standards for each layer. In particular, operating system (OS) layer 122a sits on top of hardware (HW) layer 120. Java virtual machine (JVM) layer 124a sits on top of OS layer 122a and open services gateway initiative (OSGI) layer 126a sits on top of JVM layer 124a. Java telematics client (JTC) layer 460 sits on top of OSGI layer 126a. Included within JTC layer 460 are is user interface (UI) manager 464, communication framework 516a and preference manager 466. It should be appreciated that UI manager 464 enables a user interface display within the vehicle for a user to interact with the TCU. Of course, the user interface may be a voice only interface. Communications framework 516a of TCU 452 is configured to communicate with communication framework 516b of JPS 448 through network 446 and is described in more detail with reference to FIG. 7. Carlets C₁ through Cₙ 462 are client applications that provide the functionality a user specifies through the preferences of the preference manager in one embodiment of the invention. It should be appreciated that synchronization between the preferences on the client side and the preferences on the server side is accomplished through communication between the preference manager of the client side and the preference server of the server side. The communication link is established over a network through a communication frameworks 516a on the client side and 516b on the server side.

FIG. 7 illustrates communication between a carlet application and the communications framework on the client side in accordance with one embodiment of the invention. For purposes of simplicity, the detailed components of the communications framework 516a are only shown from the perspective of the client side, although it should be understood that the server side has a similar communication framework 516b to establish and enable synchronous communication between the client side (e.g., a telematics control unit on a vehicle) and the server side (e.g., a telematics Java provisioning server). The Java provisioning server is charged with communicating with any number of clients. Such clients may be from any number of vehicles, makes, models, etc, while the client side is specific to a particular vehicle and TCU implementation.

The communications framework 516a will include a message manager 517, a stream manager 519, a data multiplexer and flow controller 518c (i.e., to function as a data pump), a policy manager 520, a channel monitor 522, and an interface to the various physical channels available to the communications framework of the client side. A synchronization control 527 is provided to interface between the client side and the server side. Specifically, the synchronization control 527 will enable communication between the data multiplexer and flow controller 518c of the client side, and the data multiplexer and flow controller 518s of the server side.

In operation, when a particular carlet application 502 is requested, the carlet will communicate 515 with the stream manager 519 and request that a connection be established. In the request, the carlet, in one embodiment, will provide properties detailing what type of connection is needed to satisfy the carlet's bandwidth requirements. As noted above, if the carlet is an MP3 carlet, the properties may designate a particular minimum transfer rate. In response, the stream manager 519 will request a connection object (Conn. OBJ) 518a from the data multiplexer and flow controller 518c. If a channel satisfying the desired bandwidth is available, the data multiplexer and flow controller 518c will return a connection object (Conn. OBJ) 514a back to the carlet. The message manager 517 is generally used to obtain connection objects for one-way communication, not unlike a one way email.

Accordingly, a communication link will be established between the carlet application 502 via the connection objects 514a and 518a of the data multiplexer and flow controller 518c. In one embodiment, the connection object 518a of the data multiplexer and flow controller 518c has the ability to switch between channels 525 that are available to the communications framework 516a of the client side. For instance, the data multiplexer and flow controller connection object 518a may initially establish a connection 524 to a channel 1 (CH 1). Connection 524 will thus communicate with a complementary channel 1 (CH 1) of the server side. The policy manager 520, is preferably a pluggable policy that can be custom tailored for the particular application or based on user specifications. For instance, the policy manager may contain code that will enable selection of different channels depending upon availability, the type of communication desired, bandwidth requirements for a given data transfer or transfers, payment of a bandwidth fee, subscription level, etc.

Assume in one example that the connection objects 514a and 518a have been established and are enabling data flow over connection 524 through channel 1. At some point in time, possibly when the client (e.g., a vehicle with a telematics control unit) enters a zone of higher bandwidth (e.g., such as a gas station with high wireless bandwidth services), channel 2 (CH 2) will become available. Its availability is detected by the channel monitor 522 of the communications framework 516a. If channel 2 is more desirable than channel 1, based on the policy set by the policy manager 520, the connection object 518a will initiate a switch to channel 2.

The switch to channel 2 will then be synchronized using the synchronization control 527, such that data being transferred between the client side and the server side achieve synchronization (i.e., thus preventing data loss during the switch). For instance, the data flow over connection 524 may be stopped causing a backup at the carlet application side. Any data still in the process of being transferred over channel 1 would be allowed to complete before allowing the connection object 518a to switch to channel 2. This synchronization between the client side and server side will enable channel switching, while preventing loss of data. Accordingly, once the connection object 518a has established synchronization between the client side and the server side, and the connection object 518a has switched from channel 1 to channel 2, the data flow is allowed to continue over connection objects 514a and 518a through channel 2. If any data was backed up at the client side, that data is then allowed to flow through channel 2.

This process would then continue depending upon the policy set by the policy manager, and based upon the continual monitoring of each of the available channels by the channel monitor 522. For instance, a carlet may have more than one connection open as illustrated by connection object 514b, and connection object 518b of data multiplexer and flow controller 518c.

In certain circumstances, a connection object 518b may lose a connection 526 due to a break in the transmission capability of a particular channel (e.g., by going out of range of a current wireless network). If this were to occur, the detection of the unavailability of channel 4 (CH 4), would be identified by the channel monitor 522. The connection object 518b would then determine whether the channel that became unavailable was actually in use. In one example, the channel may not actually be in use, but its loss in availability would still be detected, thus preventing its selection. In another example, it is assumed that channel 4 was in use. In such a case, data may have been lost due to the sudden drop in communication. When this occurs, the connection object 518b would communicate with a connection object 514b of the carlet to determine if data was in fact lost. If data was lost, a request would be made to the carlet for the lost data in case the carlet was sending data to the server, or a request would be made to the server for the lost data in case the server was sending data to the carlet.

The policy manager would then be queried to determine which one of the remaining channels being monitored by the channel monitor 522 would be most preferable to switch to, to continue the connection established between connection objects 514b and 518b. In this example, the connection object 518b would switch to connection 526′ over channel 5 (CH 5), which may be a slower connection, although, the connection would be transparently re-established to enable continual data transmission. To complete the switch, the synchronization control 527 would work in conjunction with the client side and the server side to ensure that data being communicated between each of the data multiplexer and flow controllers 518c and 518s is synchronized, and any dropped data is retransmitted. Because the channel monitor 522 continues to monitor each of the channels, if the more preferred channel were to come back on, a transparent switch would again occur, as discussed with reference to the channel switch between connections 524 and 524′.

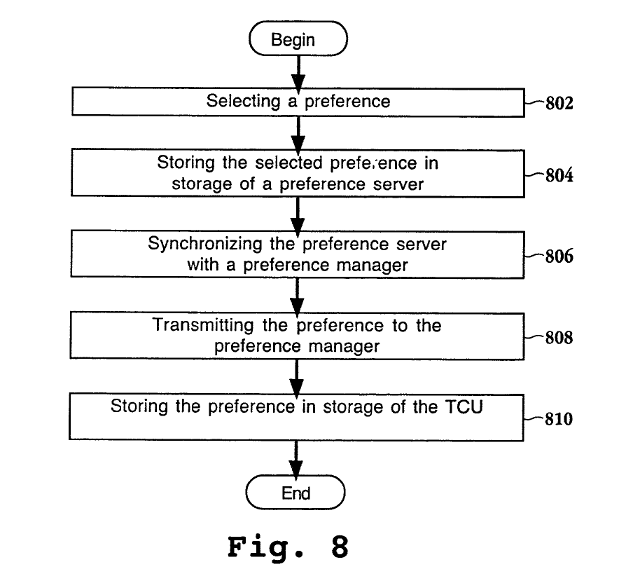

FIG. 8 is a flowchart diagram of the method operations performed for setting a preference in a TCU in accordance with one embodiment of the invention. The method initiates with operation 802 where a preference is selected. In one embodiment, the preference is one of a system preference and a user preference. The method then advances to operation 804 where the selected preference is stored in storage associated with the preference server. One skilled in the art will appreciate that the selected preference can be designated through a web page accessed with a web enabled device such as a personal computer, portable computer, PDA, mobile phone, etc. The method then proceeds to operation 806 where the preference server is synchronized with the preference manager. A suitable process for synchronizing the preference server and the preference manage is described with reference to FIG. 7. In one embodiment, a synchronization control in communication with the communication frameworks of the server and the client enables the synchronization. The method then moves to operation 808 where the selected preference is transmitted to the preference manager. In one embodiment, where the preference is uploaded while the TCU is in a sleep mode, the preference is transmitted from the server upon the vehicle containing the TCU starting. The method then advances to operation 810 where the selected preference is stored in storage associated with the TCU. It should be appreciated that the user has access to the selected preference upon transmittal of the preference to the TCU.

While FIG. 8 discusses a method of storing a preference from the server to the client, it should be appreciated that the method can also be applied from the client to the server. That is, a user has the capability to add, change, or modify preferences from the vehicle through a user interface of the TCU. The selected preference is stored in the TCU and then the preference manager and the preference server is synchronized. The selected preference is then transmitted to the preference server form the preference manager, where it is stored on the server side.

As an overview, the Java virtual machine (JVM) is used as an interpreter to provide portability to Java applications. In general, developers design Java applications as hardware independent software modules, which are executed Java virtual machines. The Java virtual machine layer is developed to operate in conjunction with the native operating system of the particular hardware on which the communications framework 516c is to run. In this manner, Java applications (e.g., carlets) can be ported from one hardware device to another without requiring updating of the application code.

Unlike most programming languages, in which a program is compiled into machine-dependent, executable program code, Java classes are compiled into machine independent byte-code class files which are executed by a machine-dependent virtual machine. The virtual machine provides a level of abstraction between the machine independence of the byte-code classes and the machine-dependent instruction set of the underlying computer hardware. A class loader is responsible for loading the byte-code class files as needed, and an interpreter or just-in-time compiler provides for the transformation of byte-codes into machine code.

More specifically, Java is a programming language designed to generate applications that can run on all hardware platforms, small, medium and large, without modification. Developed by Sun, Java has been promoted and geared heavily for the Web, both for public Web sites and intranets. Generally, Java programs can be called from within HTML documents or launched standalone. When a Java program runs from a Web page, it is called a “Java applet,” and when run on a Web server, the application is called a “servlet.”

Java is an interpreted language. The source code of a Java program is compiled into an intermediate language called “bytecode”. The bytecode is then converted (interpreted) into machine code at runtime. Upon finding a Java applet, the Web browser invokes a Java interpreter (Java Virtual Machine), which translates the bytecode into machine code and runs it. Thus, Java programs are not dependent on any specific hardware and will run in any computer with the Java Virtual Machine software. On the server side, Java programs can also be compiled into machine language for faster performance. However a compiled Java program loses hardware independence as a result.

Although the present invention is described based on the Java programming language, other programming languages may be used to implement the embodiments of the present invention, such as other object oriented programming languages. Object-oriented programming is a method of creating computer programs by combining certain fundamental building blocks, and creating relationships among and between the building blocks. The building blocks in object-oriented programming systems are called “objects.” An object is a programming unit that groups together a data structure (instance variables) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction to the object to execute a certain method. It consists of a method selection (name) and a plurality of arguments that are sent to an object. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. A class defines a type of object that typically includes both instance variables and methods for the class. An object class is used to create a particular instance of an object. An instance of an object class includes the variables and methods defined for the class. Multiple instances of the same class can be created from an object class. Each instance that is created from the object class is said to be of the same type or class.

A hierarchy of classes can be defined such that an object class definition has one or more subclasses. A subclass inherits its parent's (and grandparent's etc.) definition. Each subclass in the hierarchy may add to or modify the behavior specified by its parent class.

To illustrate, an employee object class can include “name” and “salary” instance variables and a “set_salary” method. Instances of the employee object class can be created, or instantiated for each employee in an organization. Each object instance is said to be of type “employee.” Each employee object instance includes the “name” and “salary” instance variables and the “set_salary” method. The values associated with the “name” and “salary” variables in each employee object instance contain the name and salary of an employee in the organization. A message can be sent to an employee's employee object instance to invoke the “set_salary” method to modify the employee's salary (i.e., the value associated with the “salary” variable in the employee's employee object).

An object is a generic term that is used in the object-oriented programming environment to refer to a module that contains related code and variables. A software application can be written using an object-oriented programming language whereby the program's functionality is implemented using objects. Examples of object-oriented programming languages include C++ as well as Java.

Furthermore the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the TCU discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A system for storing preferences on a telematics client, comprising:
a telematics server configured to receive a request containing modification data for preferences, the modification data for the preferences stored on a preference server of the telematics server, the telematics server including a server side communications framework in communication with the preference server;
a telematics control unit (TCU) having a preference manger for storing the preferences, the TCU including a client side communications framework in communication with the preference manager, wherein the preference manager and the preference server are configured to synchronize over a network connection to allow the modification data to be communicated between the preference server and the preference manager.

2. The system of claim 1, wherein the TCU includes a software stack having a hardware layer, an operating system layer, a Java virtual machine layer, an open services gateway initiative layer and a Java telematics client layer.

3. The system of claim 1, wherein the preferences are one of a system preference, an application preference and a user preference.

4. The system of claim 1, wherein synchronization between the client side and the server side is established through a connection object.

5. The system of claim 1, wherein a synchronization control enables communication between the client side communications framework, and the server side communications framework.

6. The system of claim 1, wherein the client side communications framework includes a data mutliplexer and a flow controller.

7. The system of claim 1, wherein the server side communications framework includes a data mutliplexer and a flow controller.

8. The system of claim 4, wherein the connection object of the client side has the ability to switch between channels available to the client side communication framework.

9. A telematics control unit (TCU), comprising
a software stack, the software stack including;
an operating system (OS) layer;
a Java virtual m a chine (JVM) layer;
a service gateway layer; and
a Java telematics client (JTC) layer, the JTC layer including;
a client side communication framework configured to communicate with a server side communication framework;
a user interface manager; and
a preference manager in communication with the client side communication framework, the preference manager configured to store at least one preference.

10. The TCU of claim 9, wherein the preference is one of a system preference, an application preference and a user preference.

11. The TCU of claim 9, wherein the JTC layer further includes:
carlets executed by the JTC layer, the carlets executing functionality specified by the preference.

12. The TCU of claim 9, wherein the client side communications framework further includes;
a message manager providing one way communication;
a stream manager providing two way communication, the stream manager configured to receive a request that a connection be established from a carlet; and
a data mutliplexer and a flow controller configured to receive a request from the stream manager for a connection object, wherein in response to the request, the data mutliplexer and the flow controller return a connection object to the carlet to establish a connection.

13. A method for storing preferences associated with a telematics system, comprising:
selecting a preference;
storing the selected preference in storage of a preference server;
synchronizing the preference server with a preference manager of a telematics control unit (TCU);
transmitting the preference to the preference manager; and
storing the preference in storage of the TCU.

14. The method of claim 13, wherein the method operation of synchronizing the preference server with a preference manager further includes:
requesting a connection object from a data multiplexer and flow controller; and
determining whether a desired channel is available.

15. The method of claim 13, wherein the preference is one of a system preference and a user preference.

16. The method of claim 13, wherein the system preference includes one of a vehicle identification number, a driver's license number, a license plate number and a telephone number for connecting to a server.

17. The method of claim 13, wherein the user preference is an infotainment or convenience preference.

18. The method of claim 13, wherein the method operation of selecting a preference further includes;
accessing a distributed network in communication with the preference server; and
inputting the preference through a user interface.

19. The method of claim 18, wherein the user interface is a web page.

20. The method of claim 13, wherein the method operation of synchronizing the preference server with a preference manager of a TCU further includes:
initiating the synchronization upon power-up of the TCU.
